(19) United States
(12) Patent Application Publication
(10) Pub. No.: US 2023/0230010 A1
(43) Pub. Date: Jul. 20, 2023

(54) SYSTEM AND METHOD FOR SCALABLE OPTIMIZATION OF INFRASTRUCTURE SERVICE HEALTH

(71) Applicant: salesforce.com, inc., San Francisco, CA (US)

(72) Inventors: Gautham Ramachandran, San Francisco, CA (US); Gerald Gibson, JR., Indianapolis, IN (US); Zeqiang Wang, Redmond, WA (US); Ana Bertran, San Francisco, CA (US)

(21) Appl. No.: 17/578,642

(22) Filed: Jan. 19, 2022

(51) Int. Cl. G06Q 10/06; G06Q 30/02

(52) U.S. Cl. CPC G06Q 10/06393; G06Q 30/0201

(57) ABSTRACT

Methods, computer readable media, and devices for quantifying an infrastructure service health as a score and optimizing performance of the infrastructure service based on benchmarks of dynamically identified control groups are disclosed. One method may include determining, for an infrastructure service of an organization, a metric health score for one or more metrics and an overall health score for the organization, creating, for at least one of the metrics, a number of control groups based on a timeframe criteria and including a set of organizations having a metric health score for the timeframe criteria similar to the organization, and maximizing performance of the infrastructure service using machine learning to compare, for at least one metric, performance impacts to the organization based on service changes with the number of control groups for the at least one metric.

### TECHNICAL FIELD

Embodiments disclosed herein relate to techniques and systems for quantifying an infrastructure service health as a score and optimizing performance of the infrastructure service based on benchmarks of dynamically identified control groups.

### BACKGROUND

Optimization of a system offering, such as a marketing system, sales systems, or the like, may rely on a holistic view of various sub-systems on which the offering depends. However, the various sub-systems may be managed by different organizations and may vary across different users and different channels.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 is a block diagram illustrating a system for scalable optimization of infrastructure service health according to some example implementations.

FIG. 2 is a flow diagram illustrating a method for scalable optimization of infrastructure service health according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Embodiments disclosed herein provide techniques and systems for quantifying an infrastructure service health as a score and optimizing performance of the infrastructure service based on benchmarks of dynamically identified control groups. In particular, disclosed embodiments may enable optimization of an infrastructure service for a particular customer based on service performance for a dynamically defined group of peer customers.

In one example, a marketing campaign may involve activities across a number of marketing channels, such as email, social media, display, and the like. Various infrastructure services may be utilized to support these channels. For example, a mail transfer agent (MTA) may be utilized to transfer email messages to internet service providers for delivery to mailbox endpoints. The performance of these various infrastructure services may depend on a number of factors, such as message size, message complexity, volume, and the like. However, different service organizations may be responsible for or otherwise engaged in providing the various infrastructure services (e.g., MTAs operated by one service organization while display operated by another service organization). Furthermore, different customer organizations may utilize services provided by different service organizations. For example, customer A may utilize MTAs managed by service organization 1 and customer B may utilize MTAs managed by service organization 2. As such, it may be difficult to develop a holistic view of how well an offering, such as the marketing campaign in the one example, is performing for a single customer organization or a plurality of organizations.

As disclosed herein, an offering may be enhanced by optimizing performance of infrastructure services utilized by the offering. In particular, performance metrics from various infrastructure services may be collected for a plurality of organizations. In turn, an infrastructure health score for an infrastructure service utilized by an organization may be determined for the organization and an overall health score, based on the various infrastructure health scores of the organization, may be determined for the organization. In order to maximize performance of the infrastructure services, changes in how the services are utilized (e.g., change in message complexity, change in message volume, etc.) may be evaluated and resulting infrastructure health scores and overall health scores may be compared between a target organization and a number of control groups of organizations having similar scores as the target organization. For example, Bayesian market matching causal inferences may be used to assess and prioritize significant impact to the target organization's service health due to changes compared to similar causal inferences to other organizations in the number of control groups without the changes. In this way, an offering utilized by an organization may be enhanced by maximizing performance of the various infrastructure services of the offering for the organization based on comparisons with peer organizations.

In various implementations, a metric health score for one or more metrics may be determined. The one or more metrics may include, for example, reliability, error rate, availability, duration, saturation, or the like. The one or more metrics may be associated with an infrastructure service, such as email, social, display, or the like. In some implementations, the metric health scores are determined for individual organizations within a plurality of organizations. That is, one organization may have one set of metric health scores for one infrastructure service and another organization may have another set of metric health scores for that one infrastructure service. In various implementations, an organization's one or more metric health scores for an infrastructure service may be combined to generate an overall health score of the infrastructure service for the organization. As such, a first organization may have one overall health score for one infrastructure service and a second organization may have another overall health score for the one infrastructure service.

In various implementations, a number of control groups may be dynamically created for the one or more metrics in relation to a particular organization. For example, a number of control groups may be dynamically created for saturation, a number of control groups for duration, a number of control groups for availability, a number of control groups for error rate, and a number of control groups for request rate. The number of control groups may be based, for example, on a timeframe criteria. For example, the number of control groups may include a control group based on an hour of day timeframe, a control group based on a day of week timeframe, a control group based on a week of year timeframe, and a control group based on a holidays of year timeframe. A control group may include, for example, other organizations having similar metric health scores for a metric during a timeframe as the particular organization. In some implementations, a control group may be dynamically created by comparing a metric health score of the particular organization with metric health scores of other organizations and selecting organizations with similar metric health scores.

In various implementations, performance of an infrastructure service for a target organization may be maximized by using machine learning to compare changes in performance for the target organization resulting from service utilization changes (e.g., change in message complexity, etc.) with performance of peer organizations (i.e., dynamically defined control groups) without service utilization changes. For example, a target organization may implement changes in how the organization utilizes an offering and additional metric health scores as well as an overall health score may be determined for the target organization. Bayesian market matching causal inferences may utilize these additional metric health scores to assess and prioritize significant impact to the target organization's service health as compared to organizations without such changes in the dynamic control groups. In this way, the offering may be enhanced for the target organization based on a holistic view of the various infrastructure services as well as peer organizations.

Implementations of the disclosed subject matter provide methods, computer readable media, and devices for quantifying an infrastructure service health as a score and optimizing performance of the infrastructure service based on benchmarks of dynamically identified control groups. In various implementations, a method for optimizing infrastructure service health may include, for at least one of a plurality of organizations, determining, for an infrastructure service, a metric health score for one or more metrics and an overall health score for the at least one organization, creating, for at least one of the one or more metrics, a number of control groups, and maximizing performance of the infrastructure servicing using machine learning to compare, for at least one metric, performance impacts to the at least one organization based on one or more service changes with the number of control groups for the at least one metric.

In some implementations, the overall health score may be a combination of the one or more metric health scores.

In some implementations, a control group may be based on a timeframe criteria and may include a subset of the plurality of organizations. In some implementations, the subset may include organizations having, for the at least one metric, a metric health score for a timeframe criteria similar to the at least one organization.

In some implementations, the infrastructure service may be selected from the list including email, social, and display.

In some implementations, the one or more metrics may be selected from the list including request rate, error rate, availability, duration, and saturation.

In some implementations, the timeframe criteria may be selected from the list including hour of day, day of week, week of year, and holidays of year.

In various implementations, maximizing performance of the infrastructure service using machine learning to compare, for at least one metric, performance impacts to the at least one organization based on one or more service changes with the number of control groups of the at least one metric may include, for at least one of the number of control groups, comparing Bayesian market matching causal inferences of the one or more service changes for the at least one organization with Bayesian market matching causal inferences of the at least one control group.

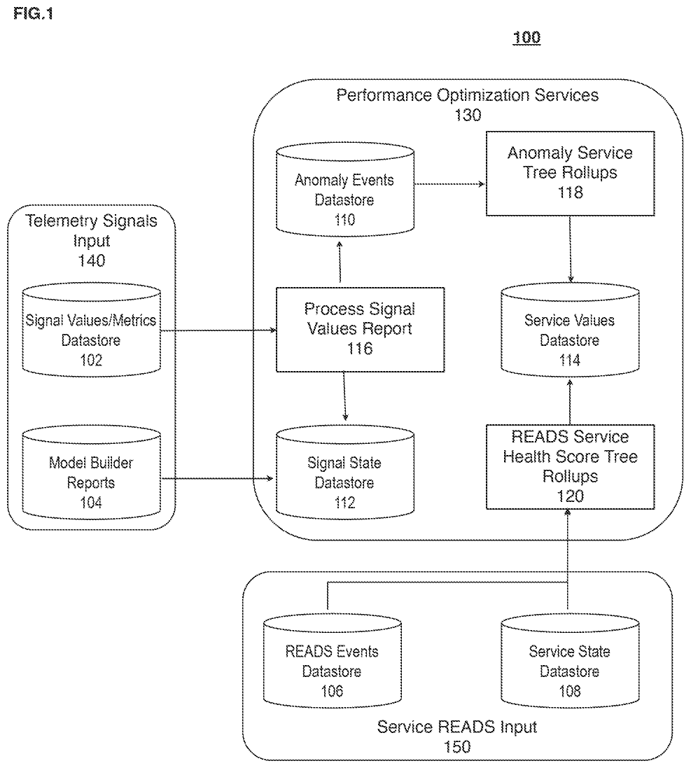

FIG. 1 illustrates a system 100 for quantifying an infrastructure service health as a score and optimizing performance of the infrastructure service based on benchmarks of dynamically identified control groups according to various implementations of the subject matter disclosed herein. In various implementations, system 100 may include performance optimization services 130, telemetry signals input 140, and service reliability, error rate, availability, duration, and saturation (READS) input 150.

Telemetry signals input 140 may include, for example, signal values/metrics datastore 102 and model builder reports 104. In some implementations, signal values/metrics datastore 102 may be, for example, a database, a data store, a data file, or the like that includes information about how an infrastructure service has performed historically. The “signal values” are the actual values used to determine a health score as disclosed herein. For example, a “duration” may be used as a signal value/metric. A typical duration for a system in 5-minute time period is 500 milliseconds. This value is used to compute the health score of the associated system for the time period. In some implementations, model builder reports 104 may include information about expectations of how an infrastructure service is to perform, such as a service level agreement or the like. More generally, a model builder report captures parameters from a model. For example, an anomaly detection model builder report captures the upper threshhold to be tracked for a signal value to exceed or stay within bounds, i.e., to be considered an anomaly or not.

Service Reliability, Errors, Availability, Duration, and Saturation (READS) input 150 may include, for example, READS events datastore 106 and service state datastore 106. Each signal stored in the events datastore 106 falls into one of the READS categories. For example, a time-based signal would be considered a Duration-type signal. In some implementations, READS events datastore 106 may be, for example, a database, a data store, a data file, or the like that includes information about or that otherwise describes events related to reliability, error rate, availability, duration, and saturation associated with an infrastructure service. In some implementations, service state datastore 108 may be, for example, a database, a data store, a data file, or the like that includes information about a state of an infrastructure service. The service state datastore 108 may include any data that indicates the state of a service during the considered time period. For example, a “recent health score” may be stored that indicates the state of a service from the last time it was calculated. A service's health score may be the sum of health scores for other contributing scores, such as a Key Performance Indicator (KPI) health score, the health score for a sub-service, or the like, which may be modified by a weight assigned based on the contributing score's importance. As another example, the datastore 108 may store statistics about anomaly events or scores identified and/or calculated over a period of time.

In various implementations, performance optimization services 130 may include, for example, anomaly events datastore 110, signal state datastore 112, service values datastore 114, process signal values report 116, anomaly service tree rollups 118, and READS service health score tree rollups 120. In some implementations, process signal values report 116 may, for example, receive metrics from signal values/metrics datastore 102, process the received metrics, and provide the processed metrics to anomaly events datastore 110 and/or signal state datastore 112. Signal state datastore 112 may, for example, receive processed metrics from process signal values report 116 as well as information regarding service level agreements from model builder reports 104 and store the various metrics and information in a datastore, such as a database, data file, or the like. Anomaly events datastore may, for example, receive processed metrics from process signal values report 116 and, in turn, provide information about anomaly events to anomaly service tree rollups 118.

In some implementations, anomaly service tree rollups 118 may, for example, receive information about anomaly events from anomaly events datastore 110 and provide the received information to service values datastore 114. In some implementations, READS service health score tree rollups 120 may, for example, receive information about READS events from READS events datastore 106 and receive service state information from service state datastore 108. After receiving READS events information and service state information, READS service health score tree rollups 120 may, for example, provide combined READS events information and service state information to service values datastore 114. Service values datastore 114 may be, for example, a data store, a data base, a data file, or the like. The various information stored in service values datastore 114 may, for example, be utilized to quantify an infrastructure service health as a score and optimize performance of the infrastructure service.

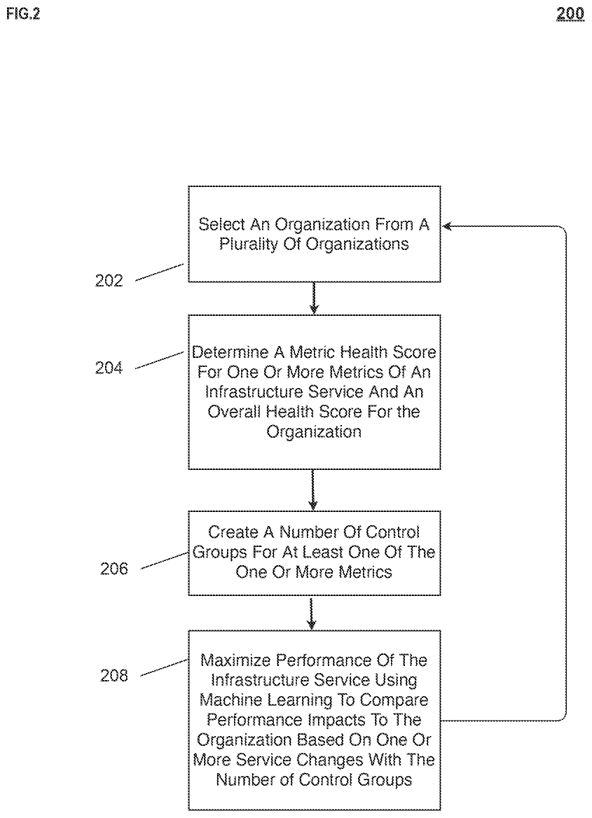

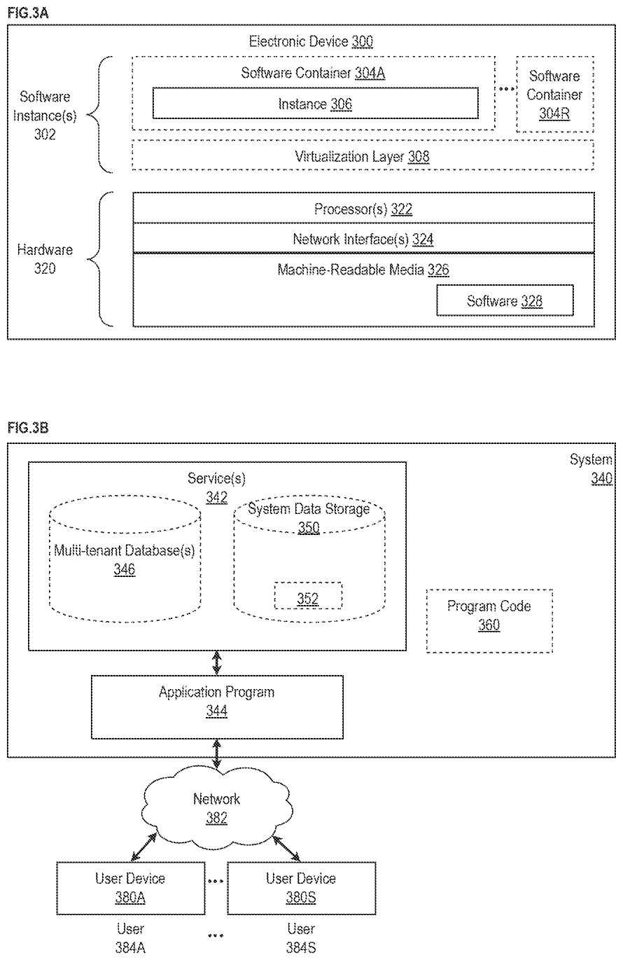

FIG. 2 illustrates a method 200 for quantifying an infrastructure service health as a score and optimizing performance of the infrastructure service, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In step 202, an organization may be selected from a plurality of organizations. In various implementations, the plurality of organizations may include, for example, organizations that utilize one or more infrastructure services. The selected organization may, for example, be an organization that utilizes an infrastructure service such as email, social, display, or the like.

In step 204, a metric health score for one or more metrics of an infrastructure service and an overall health score for the selected organization may be determined. For example, the selected organization may utilize an email infrastructure service. In this one example, the email infrastructure service may have one or more metrics associated with the service. The one or more associated metrics may, for example, provide information about the performance of the service. The one or more metrics may include, for example, a reliability metric, an error rate metric, an availability metric, a duration metric, a saturation metric, and the like. A metric health score may, for example, represent a numerical value within a range of values, such as 0 to 100. In some implementations, a metric health score may, for example, be calculated based on metrics associated with the service and expected performance of the service, such as a service level agreement. For example, a metric health score may be calculated as (1 — min(metric, expected performance) / expected performance) * 100%.

Further in this one example, the email infrastructure service may have an overall health representing an overall performance of the service for the selected organization. The overall health score of the service for the selected organization may be, for example, a combination of metric health scores for the one or more metrics of the infrastructure service.

In step 206, a number of control groups may be created for at least one of the one or more metrics. In various implementations, a control group may be based on a timeframe criteria, such as hour of day, day of week, week of year, holidays of year, or the like. A control group may include, for example, a subset of organizations from the plurality of organizations. The subset of organizations may, for example, include organizations that have a metric health score similar to the selected organization's metric health score for the at least one metric.

In the email infrastructure service example, a number of control groups may be created for the reliability metric, a number of control groups may be created for the error rate metric, a number of control groups may be created for the availability metric, a number of control groups may be created for the duration metric, and a number of control groups may be created for the saturation metric. For example, for the reliability metric, a control group may be created based on an hour of day, a control group may be created based on a day of week, a control group may be created based on a week of year, and a control group may be created based on holidays of year. As such, in this example, a metric may have four associated control groups. A control group may include organizations that have a similar metric health score for the timeframe. For example, for the hour of day control group for the reliability metric, organizations having a similar reliability metric health score for the hour of day may be included in the control group. Of note, a control group represents a set of “peer” organizations to the selected organization for which the infrastructure service has similar performance during the timeframe on which the control group is based.

In step 208, performance of the infrastructure service may be maximized by using machine learning to compare performance impacts to the organization based on one or more service changes with the number of control groups. In various implementations, the machine learning may utilize a comparison of Bayesian market matching causal inferences (which may also be referred to in the art as “Bayesian matching methods”) of one or more service changes for the selected organization with Bayesian market matching causal inferences of at least one control group. In the email infrastructure service example, a message complexity may be decreased and machine learning may be utilized to compare performance of the service with this decreased complexity for the selected organization with performance of the service without changes for the control group of organizations. If the decreased complexity represents an improvement, such change may be implemented. As another example for the email infrastructure service, mail transfer agents may be adjusted to prioritize delivery of the selected organization's messages and impacts of this adjustment may be compared to the control group to determine whether the adjustments represent an improvement for the service.

In this way, performance of an infrastructure service may be enhanced. As disclosed herein, an infrastructure service health may be quantified as a score and performance of the infrastructure service may be optimized. Of note, such performance may be optimized without exposing customer specific details outside of an organization and without regard to whether disparate infrastructure services are operated and/or maintained by different organizations. That is, information may be collected from a number of disparate infrastructure services and a holistic view may be provided to a specific organization without providing identifying information of other organizations. Such a holistic view is unavailable in a traditional approach.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals — such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method for optimizing infrastructure service health, the method comprising:
for at least one of a plurality of organizations:
determining, for an infrastructure service, one or more metric health scores for one or more metrics and an overall health score for the at least one organization, the overall health score being a combination of the one or more metric health scores;
for at least one of the one or more metrics, creating a number of control groups, a control group:
being based on a timeframe criteria; and
comprising a subset of the plurality of organizations, the subset comprising organizations having, for the at least one metric, a metric health score for the timeframe criteria similar to the at least one organization; and
maximizing performance of the infrastructure service using machine learning to compare, for at least one metric, performance impacts to the at least one organization based on one or more service changes with the number of control groups for the at least one metric.

2. The computer-implemented method of claim 1, wherein the infrastructure service is selected from the list comprising:
email;
social; and
display.

3. The computer-implemented method of claim 1, wherein the one or more metrics is selected from the list comprising:
request rate;
error rate;
availability;
duration; and
saturation.

4. The computer-implemented method of claim 1, wherein the timeframe criteria is selected from the list comprising:
hour of day;
day of week;
week of year; and
holidays of year.

5. The computer-implemented method of claim 1, wherein maximizing performance of the infrastructure service using machine learning to compare, for at least one metric, performance impacts to the at least one organization based on one or more service changes with the number of control groups of the at least one metric comprises:
for at least one of the number of control groups:
comparing Bayesian market matching causal inferences of the one or more service changes for the at least one organization with Bayesian market matching causal inferences of the at least one control group.

6. A non-transitory machine-readable storage medium that provides instructions that, if executed by a processor, are configurable to cause the processor to perform operations comprising:
for at least one of a plurality of organizations:
determining, for an infrastructure service, one or more metric health scores for one or more metrics and an overall health score for the at least one organization, the overall health score being a combination of the one or more metric health scores;
for at least one of the one or more metrics, creating a number of control groups, a control group:
being based on a timeframe criteria; and
comprising a subset of the plurality of organizations, the subset comprising organizations having, for the at least one metric, a metric health score for the timeframe criteria similar to the at least one organization; and
maximizing performance of the infrastructure service using machine learning to compare, for at least one metric, performance impacts to the at least one organization based on one or more service changes with the number of control groups for the at least one metric.

7. The non-transitory machine-readable storage medium of claim 6, wherein the infrastructure service is selected from the list comprising:
email;
social; and
display.

8. The non-transitory machine-readable storage medium of claim 6, wherein the one or more metrics is selected from the list comprising:
request rate;
error rate;
availability;
duration; and
saturation.

9. The non-transitory machine-readable storage medium of claim 6, wherein the timeframe criteria is selected from the list comprising:
hour of day;
day of week;
week of year; and
holidays of year.

10. The non-transitory machine-readable storage medium of claim 6, wherein maximizing performance of the infrastructure service using machine learning to compare, for at least one metric, performance impacts to the at least one organization based on one or more service changes with the number of control groups of the at least one metric comprises:
for at least one of the number of control groups:
comparing Bayesian market matching causal inferences of the one or more service changes for the at least one organization with Bayesian market matching causal inferences of the at least one control group.

11. An apparatus comprising:
a processor; and
a non-transitory machine-readable storage medium that provides instructions that, if executed by a processor, are configurable to cause the processor to perform operations comprising:
for at least one of a plurality of organizations:
determining, for an infrastructure service, one or more metric health scores for one or more metrics and an overall health score for the at least one organization, the overall health score being a combination of the one or more metric health scores;
for at least one of the one or more metrics, creating a number of control groups, a control group:
being based on a timeframe criteria; and
comprising a subset of the plurality of organizations, the subset comprising organizations having, for the at least one metric, a metric health score for the timeframe criteria similar to the at least one organization; and
maximizing performance of the infrastructure service using machine learning to compare, for at least one metric, performance impacts to the at least one organization based on one or more service changes with the number of control groups for the at least one metric.

12. The apparatus of claim 11, wherein the infrastructure service is selected from the list comprising:
email;
social; and
display.

13. The apparatus of claim 11, wherein the one or more metrics is selected from the list comprising:
request rate;
error rate;
availability;
duration; and
saturation.

14. The apparatus of claim 11, wherein the timeframe criteria is selected from the list comprising:
hour of day;
day of week;
week of year; and
holidays of year.

15. The apparatus of claim 11, wherein maximizing performance of the infrastructure service using machine learning to compare, for at least one metric, performance impacts to the at least one organization based on one or more service changes with the number of control groups of the at least one metric comprises:
for at least one of the number of control groups:
comparing Bayesian market matching causal inferences of the one or more service changes for the at least one organization with Bayesian market matching causal inferences of the at least one control group.
